(19) United States
(12) Patent Application Publication
(10) Pub. No.: US 2008/0279726 A1
(43) Pub. Date: Nov. 13, 2008

(54) Cuvette

(75) Inventors: Jurgen Kaufmann, Denzlingen (DE); Dieter Sommer, Furtwangen (DE); Thomas Beyer, Freiburg (DE); Gerhard Meier, Freiburg (DE)

Correspondence Address: NATH & ASSOCIATES, 112 South West Street, Alexandria, VA, 22314, US

(73) Assignee: SICK MAIHAK GmbH, Waldkirch (DE)

(21) Appl. No.: 12/149,810

(22) Filed: May 8, 2008

(30) Foreign Application Priority Data
May 9, 2007 (EP) 07009290.3

(51) Int. Cl. B01J 19/00; B01L 3/00

(52) U.S. Cl. 422/83; 422/102

(57) ABSTRACT

The invention relates to a cuvette (10, 10′) having a chamber (20, 20′) which is closed by windows at the end faces and having an HF reservoir, wherein an HF resistant, porous material (30, 30′) is arranged as the HF reservoir in the chamber (20, 20′).

The invention relates to a cuvette in accordance with the preamble of claim 1.

It is known to use a laser spectrometer for the analysis of gases, in particular for in situ gas analysis. A reference cuvette is required for this laser spectrometer which contains the gas to be measured in a defined concentration. A laser spectrometer of this kind can be seen, for example, from DE 35 10 052 C2. HF is in particular used as the reference gas. It is, however, problematic in this connection that it is hardly possible to maintain gaseous HF at a constant pressure in a cuvette over longer time periods. The cause for this is in particular to be found in reactions of the HF with the walls of the cuvette and any possibly present leaks of the cuvette.

A cuvette is understood as a closed chamber with windows at the end faces. Light enters into the cuvette and exits its again through the window sand transilluminates the gas present in the cuvette in so doing.

To compensate the wall reactions and other losses of gas in the cuvette, throughflow cuvettes are, for example, known in which a gas, in particular HF, flows continuously through the cuvette. However, these cuvettes have the disadvantage that HF gas is constantly consumed. Cuvettes are of this type are thus expensive.

Cuvettes are furthermore known into which small amounts of hydrofluoric acid are filled and in which subsequently underpressure is produced. The hydrofluoric acid vaporizes so that HF gas is present in the cuvette. However, this cuvette is not stable in the long term due to the small amount of hydrofluoric acid. Residues of the hydrofluoric acid can reach the window and impair the transmission phenomena depending on the position of the cuvette. In addition, condensation can occur at the cuvette windows.

So-called permeation tubes, i.e. tubes in which dynamic gas mixtures can be produced in that gaseous analytes enter in a controlled manner into a gas flow from a storage container through a polymeric material, are furthermore known. However, sufficient long-term stability is also not ensured with such permeation tubes.

A reference cuvette is known from DE 35 10 052 C2 in which an HF reservoir is arranged to compensate losses due to leaks or reactions. For this purpose, an additional storage chamber is arranged at the actual reference chamber and is connected in a gas permeable manner to the reference chamber via a frit. The storage chamber is filled with a substance which splits HF on heating whose partial pressure depends on the temperature. HF losses in the reference chamber itself can thus be replaced from the storage chamber. However, there is also the problem with this cuvette of storing a sufficiently large amount of the substance separating the HF in the cuvette over a sufficiently long time.

It is the object of the invention to provide a cuvette in which a sufficient concentration of HF can be maintained over a long period, for example for more than six months. Furthermore, a cuvette should be provided with which measurements can also be made independently of the position.

The object of the invention is satisfied by a cuvette having the feature of claim 1.

Advantageous aspects and further developments of the invention are set forth in the dependent claims.

In accordance with the invention, an HF resistant, porous material is arranged in the chamber of the cuvette as an HF reservoir. The porous material can absorb a substance which splits HF on heating and can retain it by capillary forces. It is thereby possible to store a sufficiently large amount of a substance which splits HF, such as hydrofluoric acid or other substances, in the cuvette over a long period. HF gas vaporizes in dependence on the temperature so that a sufficiently high concentration can be achieved in the cuvette over a long period, in particular over more than six months. The use of a porous material in particular ensures that the material splitting HF does not move directly to the window of the cuvette in different positions of the cuvette and thus that the transmission of the cuvette is not impaired.

The porous material is a polyethylene foam in a particularly advantageous embodiment of the invention. This is characterized by its HF resistance and the suitable pore size to store the HF splitting substance, in particular hydrofluoric acid, over a long period.

In an advantageous embodiment of the invention, the chamber has a first chamber and a second chamber which are connected by a passage, with the first chamber serving as a measuring chamber and the HF resistant porous material being arranged in the second chamber. It is thereby prevented particularly reliably that the HF splitting substance stored in the porous material reaches the windows of the cuvette. The second chamber can in particular also be replaced separately if HF splitting substance has to be refilled.

In an alternative, particularly preferred embodiment, the HF resistant, porous material is arranged at the inner walls of the chamber, apart from the windows. This arrangement has the advantage that condensate which forms on the walls of the cuvette volume can be absorbed. This arrangement of the reservoir in particular prevents the HF splitting substance from being located directly on one of the windows depending on the position of the cuvette.

The chamber is preferably made in tubular form in this connection so that the HF resistance, porous material is in particular also arranged as a tube on the inner side of the chamber wall. Such a structure can be produced in particularly compact and cost-effective form.

On a longer use of the cuvette, droplet formation can nevertheless still occur on the windows under certain circumstances if said windows are colder than the remaining cuvette material. To prevent such droplet formation, a device for the production of a cold pole is arranged at the chamber in a particularly advantageous embodiment of the invention, with the moisture preferably condensing at said cold pole so that the windows can be kept free of condensate.

The windows of the cuvette are preferably made from calcium fluoride (CaF₂), whereas the chamber is preferably made of polytetrafluorethylene, better known under the trade name of Teflon, or of nickel plated steel.

The cuvette in accordance with the invention is preferably used as a reference cuvette in a laser spectrometer. A device in accordance with the invention for the in situ analysis of gas, in particular a laser spectrometer in accordance with the invention, has a cuvette in accordance with the invention.

The invention will be explained in detail with reference to the following Figures. There are shown

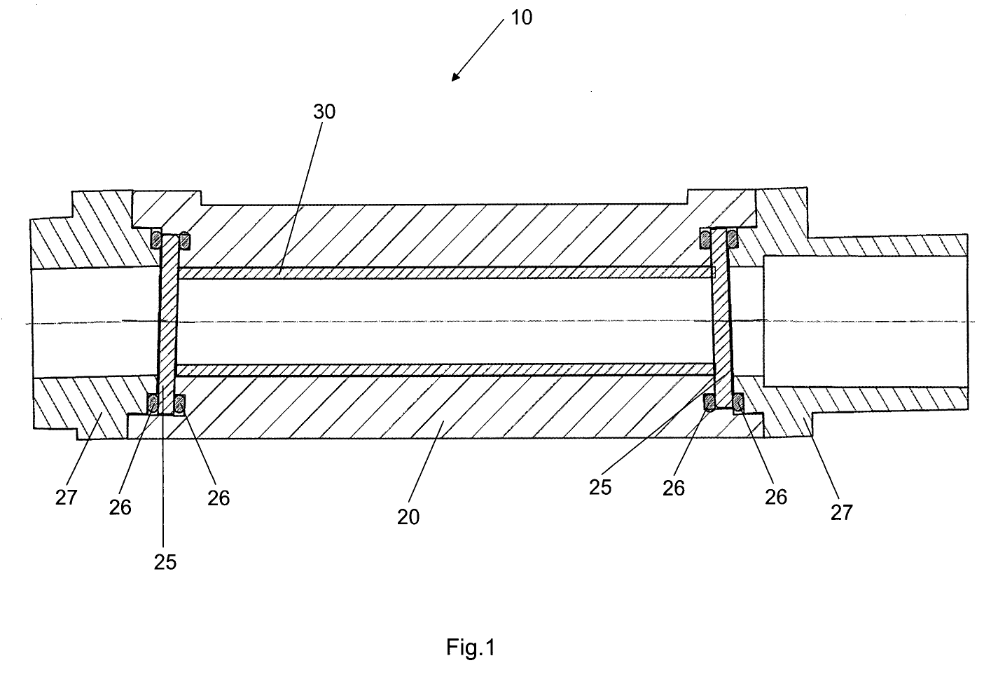

FIG. 1 a longitudinal section through a first embodiment of a cuvette in accordance with the invention; and

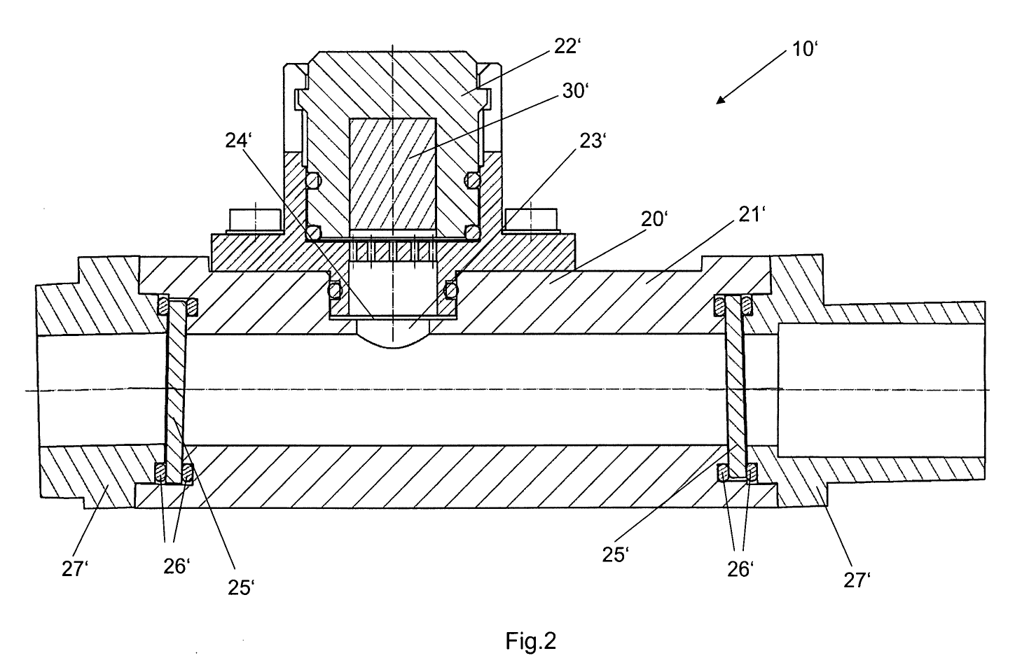

FIG. 2 a longitudinal section through a second embodiment of a cuvette in accordance with the invention.

FIG. 1 shows a longitudinal section through a cuvette 10 which has a chamber 20 which is substantially tubular. A respective window 25 is arranged at the two planoparallel end faces of the chamber 20 and is sealed toward the chamber 20 with the help of sealing rings 26. A respective holder 27 is arranged on the outer side of the windows 25 and the cuvette 10 can be inserted with it, for example, into a laser spectrometer, to be used as a reference cuvette there. The chamber 20 is produced, for example, from Teflon or nickel plated steel, whereas the windows 25 are made of calcium fluoride, for example.

An HF resistant, porous material 30 is arranged at the inner side of the tubular chamber 20. The material 30 is thus likewise arranged inside the chamber 20 in the form of a tube. In particular a polyethylene foam is used as the material 30. A substance can be retained in the porous material by capillary forces and HF gas vaporizes from it sufficiently at room temperature to achieve a sufficiently high concentration of HF gas in the cuvette 10. A suitable HF splitting substance is, for example, hydrofluoric acid. It is ensured by the arrangement of the porous material 30 on the inner side of the tubular chamber 20, with the material 30 abutting the windows 25, that HF splitting substance condensing at the windows 25 is also absorbed into the material 30 so that droplet formation on the windows 25 is prevented.

FIG. 2 shows a longitudinal section through a second embodiment of a cuvette 10′ which has a chamber 20′. The chamber 20′ is divided in this embodiment into a first chamber 21′ and a second chamber 22′, with the first chamber 21′ forming the actual measurement space and being made substantially tubular in shape. The end faces of the tubular first chamber 21′ are closed by two windows 25′ which seal the first chamber 21′ via sealing rings 26′. Holders 27′ are in turn arranged on the outer side of the windows 25′ and the cuvette 10′ can be installed into a device for the in situ analysis of gas, in particular laser spectrometers, via them. The second chamber 22′ is connected to the first chamber 21′ via a passage 23′ which is formed substantially from a bore in the chamber wall of the first chamber 21′. A Teflon membrane 24′ is arranged in the passage 23′ between the first chamber 21′ and the second chamber 22′.

An HF resistant, porous material 30′ is arranged in the second chamber 22′ and an HF splitting substance, for example hydrofluoric acid, is retained and stored in it by capillary forces. At room temperature, HF gas leaves the HF splitting substance, diffuses through the Teflon membrane 24′ into the first chamber 21′ to provide a sufficiently high concentration of HF gas there. The second chamber 22′ is arranged replaceably at the first chamber 21′ in order, optionally, to be able to replace the HF reservoir if the HF reservoir has to be filled up after longer use of the cuvette 10′.

The same materials as in the first embodiment can be used for the chamber 20′, the windows 25′ and the porous material 30′.

It is made possible in both embodiments by the use of a porous HF resistant material 30, 30′ to store an HF splitting substance in a sufficiently high amount in the material 30′ without the substance such as hydrofluoric acid flowing around in an uncontrolled manner in the interior space of the chamber 20, 20′ and being deposited, for example, on the windows 25, 25′. The cuvette 10, 10′ can thus be used independently of position and in particular enables the provision of a sufficiently high HF concentration for a sufficiently long time, in particular for more than six months, due to the use of the porous material 30, 30′.

The formation of droplets which could occur under certain circumstances on a longer use can be avoided by the use of an additional cold pole which is not shown in the Figures. If a point of the chamber 20 is cooled directly, moisture will preferably condense at this cold pole so that the windows 25, 25′ are kept free of condensate.

### REFERENCE NUMERAL LIST

10, 10′ cuvette
20, 20′ chamber
21′ first chamber
22′ second chamber
23′ passage
24′ Teflon membrane
25, 25′ window
26, 26′ sealing ring
27, 27′ holder
30, 30′ material

1. A cuvette (10, 10′) having a chamber (20, 20′) which is closed by windows (25, 25′) at the end faces and having an HF reservoir, characterized in that an HF resistant, porous material (30, 30′) is arranged as the HF reservoir in the chamber (20, 20′).

2. A cuvette in accordance with claim 1, characterized in that the HF resistant, porous material (30, 30′) is a polyethylene foam.

3. A cuvette in accordance with claim 1, characterized in that the chamber (20′) has a first chamber (21′) and a second chamber (22′) which are connected by a passage (23′), with the first chamber (21′) serving as a measurement chamber and the HF resistant, porous material (30′) being arranged in the second chamber (22′).

4. A cuvette in accordance with claim 1, characterized in that the HF resistant, porous material (30, 30′) covers at least a part of the inner walls of the chamber (20, 20′) apart from the windows (25, 25′).

5. A cuvette in accordance with claim 1, characterized in that the chamber (20, 20′) is made in tubular form.

6. A cuvette in accordance with claim 1, characterized in that a device for the production of a cold pole is arranged at the chamber (20, 20′).

7. A cuvette in accordance with claim 1, characterized in that the windows (25, 25′) are made from CaF₂.

8. Use of a cuvette (10, 10′) in accordance with claim 1 as a reference cuvette in a laser spectrometer.

9. A device for the in situ analysis of gas, in particular a laser spectrometer, having a cuvette (10, 10′) in accordance with claim 1.
